(19) United States
(12) Patent Application Publication
(10) Pub. No.: US 2005/0047980 A1
(43) Pub. Date: Mar. 3, 2005

(54) Solidifying material for a liquid organic compound, use thereof, and method of solidifying an organic compound

(76) Inventors: Hiroshi Sakaguchi, Tsukuba-shi (JP); Shinsuke Yamazaki, Tsukuba-shi (JP); Yasuo Gama, Tsukuba-shi (JP); Yoshishige Kida, Kashihara-shi (JP); Seizi Iseki, Osaka (JP)

Correspondence Address: BIRCH STEWART KOLASCH & BIRCH, PO BOX 747, FALLS CHURCH, VA, 22040-0747, US

(21) Appl. No.: 10/788,327

(22) Filed: Mar. 1, 2004

(30) Foreign Application Priority Data
Aug. 29, 2003 (JP) 2003-306361

(51) Int. Cl. C01D 15/00; C08G 63/00

(52) U.S. Cl. 423/179.5; 528/271

(57) ABSTRACT

A solidifying material for an organic compound that is liquid at 20° C. and 0.1 MPa, in which the solidifying material is obtained by the steps of: dissolving a carboxylic acid, lithium hydroxide, and urea in pure water to give a solution, gradually cooling the solution, and then precipitating crystals in a long fibrous shape from the solution; a method of producing the solidifying material; and a solidifying method of the organic compound, by using the solidifying material.

### FIELD OF THE INVENTION

The present invention relates to a solidifying material for a liquid organic compound, a production method of the same, and a method of solidifying the liquid organic compound. More specifically, the present invention relates to a solidifying material for a liquid organic compound, by using long-fibrous crystals of lithium carboxylate, a production method of the same, and a method of solidifying the liquid organic compound, by using the solidifying material.

### BACKGROUND OF THE INVENTION

The scale of petrochemical industry is enlarging year by year, and mass production and mass consumption of organic compounds are conducted. Along with those, occur, frequently worldwide, environmental pollution and accidents threatening the existence of human beings and living things: e.g. pollution in rivers, lakes, marshes and sea, which are attributable to accidents in various chemical factories, petrochemical complexes, tankers, and the like; fires; and explosions. Accordingly, safe handling and suitable treating during transportation or storage of organic compounds including petrochemical materials, are critical problems. An example of fundamental measures against these explosions, fires, leakage, and the like, include that a large amount of liquid organic compounds such as hydrocarbons handled in various chemical facilities, petrochemical complexes and tankers, and mixtures thereof are converted into safe solids, and, if necessary, returned to the original liquid one. It is thought that by conversion of the liquid organic compounds into safe solids easy to handle, many accidents would be prevented; and huge and often dangerous storage facilities, pipelines, trucking, freezing or thermally insulating facilities could be significantly modified.

Further, if the leakage accident or the like occurs, the liquid organic compound must be immediately solidified and promptly recovered. Further, it is extremely important to selectively solidify, separate and recover the organic compounds, from various waste waters discharged from factories or domestic wastes.

In consideration of these aspects, there is a demand for development of a method wherein a wide variety of liquid organic compounds handled in various chemical factories, petrochemical complexes and tankers are solidified easily, converted into safe forms, and then returned, if necessary, to the original organic compounds. Conversion of liquid organic compounds into other safe materials by a certain chemical reaction does not seem to solve the problem, and a method accompanying chemical reaction should be avoided.

Accordingly, a method of solidifying the above-mentioned various substances as they are by a physicochemical means is considered to be most preferable.

The requirements for a solidifying material for a liquid organic compound include: (1) the liquid organic compound can be solidified easily without damaging reaction units in a factory and the like, and from the thus-solidified aggregates, the original organic compound can be easily recovered, and further, the recovered solidifying material can be used by recycling; (2) the solidifying material is chemically relatively stable; and (3) since the solidifying material is supposed to be used in a large amount, the solidifying material is a safe and harmless substance, and even if the material flows outside of the reaction unit and is hardly recovered, the material itself is least dangerous for affecting to living things in the environment and to the environment per se.

Short-fibrous or long-fibrous sodium carboxylate and potassium carboxylate are proposed for such a physicochemical solidifying material (for example, see JP-A-2002-273217 (“JP-A” means unexamined published Japanese patent application)). Those short fibrous or long fibrous sodium carboxylate and potassium carboxylate are confirmed to possess exceptional collecting ability for organic compound; and to stably collect a large amount of liquid organic compound. However, those fibrous sodium or potassium carboxylates also have a room for further improvement, in such points that an effective carbon chain length thereof and an effective salt concentration thereof in an aqueous solution are limited because of relatively large solubility to water of those fibrous sodium or potassium carboxylates. Further, those fibers very stably retain their functions for a long time in a dispersed form in water. However, in some cases, a stable form changes from fibrous crystals to plate-like crystals in a dry state, resulting in a problem such as conspicuously degrading of the collecting ability for the organic compound.

### SUMMARY OF THE INVENTION

The present invention resides in a solidifying material for an organic compound that is liquid at 20° C. and 0.1 MPa, wherein the solidifying material is obtained by the steps of: dissolving a carboxylic acid, lithium hydroxide, and urea in pure water, to give a solution; gradually cooling the solution; and precipitating crystals in a long fibrous shape from the solution; and in a production method thereof.

Further, the present invention resides in a solidifying material for an organic compound that is liquid at 20° C. and 0.1 MPa, wherein the solidifying material is obtained by the steps of: completely dissolving at least one carboxylate selected from the group consisting of sodium carboxylates and potassium carboxylates, and urea in pure water, to give a solution; adding, to the solution, an aqueous lithium chloride solution; gradually cooling the solution; and precipitating crystals in a long fibrous shape from the solution; and in a production method thereof.

Other and further features and advantages of the invention will appear more fully from the following description, taken in connection with the accompanying drawing.

### BRIEF DESCRIPTION OF THE DRAWING

FIG. 1 is an optical microscope photograph showing one example of the long-fibrous crystals contained in the solidifying material of the present invention.

### DETAILED DESCRIPTION OF THE INVENTION

According to the present invention, there are provided the following means:
(1) A solidifying material for an organic compound that is liquid at 20° C. and 0.1 MPa,
   wherein the solidifying material is obtained by the steps of: dissolving a carboxylic acid, lithium hydroxide, and urea in pure water, to give a solution; gradually cooling the solution; and precipitating crystals in a long fibrous shape from the solution;
(2) The solidifying material according to the above item (1), wherein the solidifying material is obtained by further dissolving lithium chloride in the water, in the dissolving step;
(3) A solidifying material for an organic compound that is liquid at 20° C. and 0.1 MPa,
   wherein the solidifying material is obtained by the steps of: completely dissolving at least one carboxylate selected from the group consisting of sodium carboxylates and potassium carboxylates, and urea in pure water, to give a solution; adding, to the solution, an aqueous lithium chloride solution; gradually cooling the solution; and precipitating crystals in a long fibrous shape from the solution;
(4) The solidifying material according to any one of the above items (1) to (3), wherein the organic compound is a hydrocarbon;
(5) The solidifying material according to any one of the above items (1) to (3), wherein the organic compound is an edible oil;
(6) The solidifying material according to any one of the above items (1) to (5), wherein the precipitated long-fibrous crystals are dried up;
(7) A method of solidifying an organic compound that is liquid at 20° C. and 0.1 MPa, comprising:
   solidifying the organic compound, by using the solidifying material according to any one of the above items (1) to (6);
(8) A method of solidifying an organic compound that is liquid at 20° C. and 0.1 MPa, comprising the steps of:
   solidifying the organic compound, by using the solidifying material according to any one of the above items (1) to (6), to give a solid aggregate;
   heating the solid aggregates, to decompose into lithium carboxylate crystals and the liquid organic compound;
   separating the lithium carboxylate crystals from the liquid organic compound; and
   recovering the lithium carboxylate crystals for recycling;
(9) A method of producing a solidifying material for an organic compound that is liquid at 20° C. and 0.1 MPa, comprising the steps of:
   dissolving a carboxylic acid, lithium hydroxide, and urea in pure water, to give a solution;
   gradually cooling the solution; and
   precipitating crystals in a long fibrous shape from the solution;
(10) The method according to the above item (9), wherein, in the dissolving step, lithium chloride is further dissolved in the pure water; and
(11) A method of producing a solidifying material for an organic compound that is liquid at 20° C. and 0.1 MPa, comprising the steps of:
   completely dissolving at least one carboxylate selected from the group consisting of sodium carboxylates and potassium carboxylates, and urea in pure water, to give a solution;
   adding, to the solution, an aqueous lithium chloride solution;
   gradually cooling the solution; and
   precipitating crystals in a long fibrous shape from the solution.

The present inventors have studied the synthesis, dissolution, emulsification and dispersion behavior, in water, of aliphatic lithium carboxylates having alkyl groups of various lengths. As a result, we have found that these lithium carboxylates are dissolved completely in water at a high temperature by adding urea; solubility of these lithium carboxylate can be adjusted, by further adding lithium chloride, as required; by stirring and gradually cooling the compounds in a completely dissolved state, the lithium carboxylates are precipitated, for the first time, as long fibrous crystals; the long-fibrous crystals thus obtained can be stored for a long period of time, as extremely high purity crystals via purifying and drying; and these fibrous crystal aggregates can particularly efficiently solidify even various pure hydrocarbons, mixed oils such as gas oil (light oil) and fuel oil (heavy oil), and hydrophobic organic compounds, e.g. edible oils, containing a certain number of hydrophilic groups in molecules thereof. The present invention is accomplished by further studies based on these findings.

In the present invention, carboxylic acid, sodium carboxylate, or potassium carboxylate (hereinafter, these may be simply referred to as carboxylic acid or the like) that can be used in the production of the solidifying material for an organic compound being liquid at 20° C. at 0.1 MPa (hereinafter, simply referred to as a liquid organic compound), is preferably an aliphatic carboxylic acid, an aliphatic sodium carboxylate, or an aliphatic potassium carboxylate, and more preferably a compound of the structure having a straight alkyl chain. Of these, an aliphatic carboxylic acid or the like having a straight alkyl chain, is further preferable.

In the present invention, the carboxylic acid, the sodium carboxylate, or the potassium carboxylate that can be used for producing the lithium carboxylate crystals may have any alkyl chain of a straight-chain saturated chain, a straight-chain unsaturated chain, a branched saturated chain, or a branched unsaturated chain of these, preferable is one having a straight-chain alkyl chain, more preferable a straight-chain saturated alkyl chain.

Further, the carboxylic acid or the like may be composed of any of monocarboxylic acid, dicarboxylic acid, or tricarboxylic acid, and preferably composed of monocarboxylic acid.

In the present invention, the number of carbon atoms in the carboxylic acid, the sodium carboxylate, or the potassium carboxylate is preferably 9 to 18, particularly preferably 11 to 18. That is, the carboxylic acid, the sodium carboxylate, or the potassium carboxylate preferably has an appropriate length of the alkyl chain allowing: complete dissolution of the carboxylic acid or the like in pure water, by adding lithium hydroxide in the case of carboxylic acid, or adding lithium chloride in the case of sodium carboxylate or potassium carboxylate, further adding an appropriate amount of urea, and heating; and precipitation as crystals, by stirring and gradual cooling.

When the carboxylic acid is a straight-chain saturated monocarboxylic acid, nonanoic acid to octadecanoic acid are preferable. Similarly, when the sodium or potassium carboxylate is straight-chain saturated sodium or potassium monocarboxylate, sodium or potassium salts of nonanoic acid to octadecanoic acid are preferable.

Specific examples of the carboxylic acid preferably used in the present invention include decanoic acid (capric acid), dodecanoic acid (lauric acid), tetradecanoic acid (myristic acid), hexadecanoic acid (palmitic acid), octadecanoic acid (stearic acid), oleic acid, linoleic acid, and linolenic acid. Those carboxylic acids can be used singly or in combination of two or more kinds thereof.

Similarly, specific examples of the sodium or potassium carboxylate preferably used in the present invention include sodium or potassium salts of decanoic acid (capric acid), dodecanoic acid (lauric acid), tetradecahoic acid (myristic acid), hexadecanoic acid (palmitic acid), octadecanoic acid (stearic acid), oleic acid, linoleic acid, or linolenic acid. These sodium or potassium carboxylates can be used singly or in combination of two or more kinds thereof.

Each of the above components can be dissolved in pure water through usual heating means. However, methods, which can be, optionally, appropriately employed for complete dissolution, include adding a significantly high concentration of lithium chloride, raising a heating temperature to 100° C. or above, and adding a significantly high concentration of urea.

In the present invention, in the precipitation of crystals in long fibrous form, the molar ratio of the carboxylic acid (or the sodium carboxylate or the potassium carboxylate):water is preferably from (0.5:1,000) to (5:1,000), more preferably from (0.5:1,000) to (2:1,000).

Further, an amount of the lithium hydroxide is in a range of preferably 90 to 110 mol %, more preferably 95 to 105 mol %, to the carboxylic acid.

In the present invention, the amount of the urea to be added varies depending on a kind of the carboxylic acid or the like to be used, but the urea is added in preferably 1 to 16-fold molar ratio, more preferably 2 to 8-fold molar ratio, to the carboxylic acid or the like.

When using stearic acid, for example, 8 to 16-fold molar ratio of the urea is preferably added.

In the present invention, when using the carboxylic acid having 9 to 11 carbon atoms, the lithium chloride is preferably further added and dissolved in water in a ratio of 0.5 to 1 mol to the carboxylic acid, for controlling dissolution of the lithium carboxylate to be formed in water and increasing an amount of precipitation.

Further, in the present invention, when using the carboxylic acid having 12 carbon atoms, such as dodecanoic acid (lauric acid), the lithium chloride is preferably not added at all, or preferably added in an amount at most about 0.5 mol to the carboxylic acid. When using the carboxylic acid having 13 or more carbon atoms, the lithium chloride is preferably not added at all.

In the present invention, the pure water means water that is not seawater and is preferably water substantially containing no salt contents. Examples of the pure water that can be used in the present invention include distilled water, ion-exchange water, tap water, natural soft water, and ultrapure water.

To precipitate lithium carboxylate in long fibrous form, the carboxylic acid or the like must be once completely dissolved in water, before the precipitation. However, when precipitating, for example, lithium laurate C₁₁H₂₃COOLi, lauric acid alone is hardly dissolved as it is. The lauric acid eventually dissolves in hot water at 98 to 100° C. by adding a small amount of the lauric acid (1 mole of the lauric acid, to 1,000 mol of water, for example). However, only scaly, plate-like, or rod-like crystals precipitate, after cooling gradually, in an aqueous solution prepared by adding an equivalent mol of the lithium hydroxide alone. A large amount of long fibrous crystals precipitate in water, by slightly changing a molar ratio of the lauric acid and LiOH/H₂O, and by further adding about 2 mol of urea. A usual Fourier transform infrared spectroscopy (FTIR), for example, can confirm that the thus-obtained crystals as described above are in fact crystals of a lithium salt. Similarly, adjusting the amounts of carboxylic acid, sodium hydroxide, water and urea to be added allows preparation of a long-chain-like lithium salt in water, in the cases of various carboxylic acids having 9 to 18 carbon atoms.

In the present invention, “gradually cooling” means that the temperature is slowly lowered, according to a usual cooling method, from the heated state of the system to room temperature (25° C.), preferably cooling at a cooling speed of 5 to 50° C./hour.

The thickness of one long-fibrous crystal that can be used in the present invention is preferably 5 μm or less. The length of one long-fibrous crystal is preferably 100 to 2,000 μm, and more preferably 500 to 2,000 μm. Further, one long fibrous crystal is composed of a large number of finer fibrous crystals.

In the present invention, “stirring” can be conducted by selecting any of the methods conventionally used.

A temperature to completely dissolve the carboxylic acid, the sodium carboxylate, or the potassium carboxylate in water is generally 80 to 150° C., preferably 90 to 100° C., though depending on a length of an alkyl chain of the carboxylic acid or the like, an amount of the urea, and the like.

Further, the temperature for reacting the solution prepared by completely dissolving the carboxylic acid or the like in water as described above by adding lithium hydroxide (or lithium chloride when using the sodium carboxylate or the potassium carboxylate) is generally 80 to 150° C., preferably 90 to 100° C., though depending on an amount of the lithium hydroxide or the like. A reaction time thereof is generally 10 to 200 minutes, preferably 30 to 150 minutes.

One embodiment of the method of producing the solidifying material of the present invention is shown in the 1) below.

1) Carboxylic acid and urea are dissolved in pure water and suspended, and then lithium hydroxide in the approximately equivalent mol to the carboxylic acid is slowly dropped thereto, under heating and stirring. Lithium chloride is further added thereto when the carboxylic acid has short alkyl chain length. After completing the dropping, a solution temperature is slowly lowered to room temperature while continuously stirring. Further, the solution is left at rest at room temperature for a prescribed period of time, continuously stirring at room temperature or without stirring, as required.

For the lithium carboxylate having 16 or less carbon atoms, the high purity crystals are generally obtained in a uniformly dispersed form in the whole water existing in a reaction vessel, regardless of the crystal form. When long fibrous crystals are obtained, the whole content of the vessel may be in a white gel-like form with the whole water caught by the crystals. Further, the lithium carboxylate having 17 of more carbon atoms uniformly crystallize or precipitate on an upper portion or a central portion of the water, in a dispersed form in most of the water.

The obtained crystals are filtered through a suction funnel and then washed with pure water, to completely remove urea, and in some cases lithium chloride, dissolved in water, and a trace amount of carboxylic acid and lithium hydroxide possibly remaining in water. Further, the crystals are repeatedly suspended in fresh pure water, stirred, subjected to suction filtration, and washed, as required. Finally, the crystals are dried under vacuum, to obtain the solidifying material.

Another embodiment of the method of producing the solidifying material of the present invention is shown in the 2) below.

2) Sodium carboxylate or potassium carboxylate, and urea are dissolved and suspended in pure water. While heating and stirring the resultant mixture, an excess amount of lithium chloride to the sodium carboxylate or potassium carboxylate is added. A temperature of the mixture is gradually lowered to room temperature while continuing stirring. Further, the mixture is left at rest at the room temperature for a prescribed period of time continuing stirring at the room temperature or without stirring, as required. The high purity crystals are generally obtained in a uniformly dispersed form in the whole water in the reaction vessel, regardless of the crystal form. When long fibrous crystals are obtained, the whole content of the vessel may be in a white gel-like form with the whole water caught by the crystals. Then, the thus-obtained crystals are processed in the same manner as the 1) described above, to obtain the solidifying material.

The lithium carboxylate long fibers according to the present invention are more hydrophobic than sodium carboxylate long fibers. Further, since the precipitated long fibrous crystals are stable, the long fibrous crystals maintains a long fiber structure, even after the crystals are removed from the water and dried up.

Further, the reaction mixture may be preferably ripened for about 1 hour, before cooling.

Examples of the organic compound, which is in a liquid state at 20° C. and 0.1 MPa and which is capable of being solidified by the solidifying material of the present invention, include a variety of hydrocarbons, e.g. n-paraffins, olefins, branched paraffins, alicyclic hydrocarbons such as cyclohexane and the like, and aromatic hydrocarbons, as well as oil fuel A, oil fuel C, crude oil, liquid paraffin, gas oil, kerosene, mixed oil thereof, and organic compounds containing a hydrophilic group and also a hydrophobic group such as a long-chain alkyl chain, including a variety of edible oils, higher alcohols, esters, and ketones. About 5 to 100 g of the liquid organic compound can be generally solidified by 1 g of the solidifying material of the present invention, though depending on a kind of the organic compound to be solidified. To allow the solidifying material of the present invention to solidify the liquid organic compound, the solidifying material may be contacted with the liquid organic compound preferably for 1 minutes or more, more preferably with gently shaking.

The solidifying material of the present invention enables solidification of liquid organic compound through very efficient adsorption, and also enables recovery of the organic compound as macroscopic aggregates. Therefore, for example, the solidifying material can be preferably used in applications of recovering spilled oils.

The solidifying material of the present invention can be merely introduced, for example, into seawater polluted with oil fuel, thereby selectively adsorbing the oil fuel. Unless the ratio of oil fuel to the lithium carboxylate long fiber is too excessive, substantially all oil fuel are adsorbed, to float on the cleaned seawater. The solidifying material after having adsorbed the oil fuel are in the form of aggregates retaining fibrous structure when the ratio of the oil fuel is low, while the ratio of the oil fuel by mass is higher by several times than the solidifying material, the aggregates float on the sea as a whole solid spherical mass (or egg-shaped mass or an irregular-shaped mass). These aggregates or mass are maintained in a solid form, and can be separated from the seawater by scooping them up with a usual means using a net, a rake and the like.

After the solidified products (solid aggregates) which have adsorbed the liquid organic compound are separated and recovered from the spilled water, by subsequently adding water thereto and heating, they can be separated into the respective components, i.e. the lithium carboxylate crystals (long fibers) and the recovered liquid organic compound. The lithium carboxylate long fibers are separated and transferred to the aqueous phase, to be dispersed in water. The liquid organic compound can be separated and recovered from the aqueous phase. Further, a majority of the lithium carboxylate long fibers can be used again and repeatedly used for producing the lithium carboxylate long fibers usable as the solidifying material for liquid organic compounds. Generally, heating for separation of the lithium carboxylate and the liquid organic compound is conducted preferably at 80° C. or more.

The solidifying material of the present invention may be used, for example, by directly spreading the solidifying material to spilled oil at a site of the spillage oil accident, such as oceans, rivers, lakes, and marshes, in situ. An amount of the solidifying material to be spread may be suitably selected depending on a kind of the spilled oil or actual conditions of the site, but is generally about 1 to 30 mass %, preferably about 5 to 20 mass % to the mass of the spilled oil.

Further, the solidifying material of the present invention can also solidify edible oils.

Examples of the edible oils include soybean oil, cottonseed salad oil, rapeseed oil, corn oil, safflower salad oil, palm oil, sunflower oil, rice oil, sesame oil, olive oil, and the like. Generally, 1 part by mass of the solidifying material of the present invention can adsorb and solidify oils in an amount of about 15 to 100 parts by mass. To allow the solidifying material of the present invention to solidify edible oils, the solidifying material may be contacted with edible oils preferably for 1 minute or more, at room temperature or in the temperature range of from room temperature to −20° C., more preferably with gentle shaking or stirring.

The solidified products (solidified aggregates) formed after solidification of the edible oils can be separated into the respective components i.e. the lithium carboxylate long-fibrous crystals and recovered edible oils, by gently heating the aggregates at a temperature not causing deterioration on the properties and flavor of the original edible oil. A separating method is the same as the above method.

According to the present invention, it is possible to efficiently solidify a liquid organic compound through a physicochemical method.

According to the solidifying material of the present invention, an organic compound that is liquid at 20° C. and 0.1 MPa can be easily solidified, without damaging, for example, reactors in a factory. Further, original liquid organic compounds can easily be recovered from the solidified aggregates, and the recovered solidifying material can be used through recycling. Further, the solidifying material of the present invention is relatively stable, chemically. In addition, the solidifying material is a safe and harmless substance, and even if the material flows out of the reactors and is hardly recovered, the material itself is least dangerous affecting to the living things in the environment and to the environment.

Further, the solidifying material of the present invention has exceptional liquid organic compound collecting ability, and stably collects a large amount of organic compound. The solidifying material dispersed in water quite stably retains such functions for a long period of time. In addition, the dried solidifying material has stable crystals, allowing retention of high collecting ability of the organic compound.

The present invention will be described in more detail based on the following examples, but the present invention is not limited thereto.

### EXAMPLES

### Example 1

8.01 g (0.04 mol) of lauric acid (n-dodecanoic acid, n-C₁₁H₂₃COOH), 9.61 g (0.16 mol) of urea ((NH₂)₂CO), and 330 g of pure water were placed in a 500-ml Pyrex (trademark) four-necked flask, and the resultant mixture was heated using an oil bath (bath temperature was 116° C. and temperature of the aqueous solution in the flask was 95° C.). While stirring the solution at 250 rpm using a stainless-steel stirring blade, an aqueous solution containing 1.68 g (0.04 mol) of lithium hydroxide monohydrate (LiOH.H₂O) dissolved in 30 g of pure water was slowly dropped into the solution in about 30 minutes. An amount of the pure water after completing the dropping reached 360 g (20 mol). The lauric acid completely dissolved in the water as the lithium hydroxide was dropped. A large volume of bubbles generated, and the aqueous solution turned clear and colorless. During this period, the solution temperature gradually raised to reach 100° C. and became constant. The solution was further continuously stirred, maintaining 100° C., for ripening. At this time, lithium laurate was probably synthesized quantitatively and completely dissolved in water. The volume of the bubbles generated gradually decreased, but a state of the clear and colorless aqueous solution did not change at all. The heater was turned off after two hours, and the solution was gradually cooled to room temperature, stirring at a speed of 6 rpm. 30 minutes after the start of cooling, precipitation of crystals began at 83° C., and almost all precipitated by 80° C. The whole content was in a uniform, white gel-like form with the whole water in the reaction vessel caught by long fibrous crystals mutually intertwined.

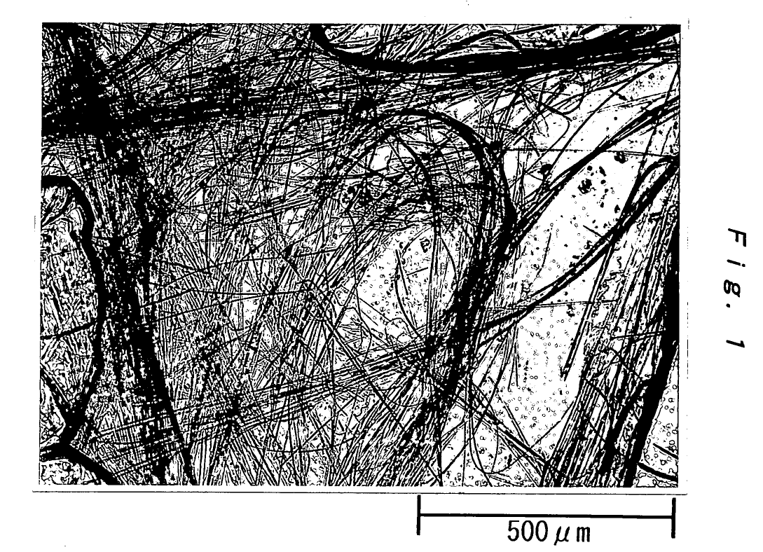

FIG. 1 shows an optical microphotograph (objective lens magnification of 10) of the thus-obtained long-fibrous crystals. Each long fiber was not a single crystal but had a long and continuous structure with assembled extremely fine and short fibers.

The long-fibrous crystals and the aqueous solution could be easily separated through suction filtration. The crystals were further washed with pure water, and the filtrate was separated to separate and remove a trace amount of the lauric acid, the lithium hydroxide, and the urea remaining in the solution. The crystals were then dried under vacuum, to prepare a solidifying material. The solidifying material was confirmed to remain stable at room temperature, over several months, even after drying under vacuum as described above. Results of elemental analysis confirmed that about 97.6% of the crystals were lithium laurate and the remaining 2.4% was urea. Further, infrared spectroscopy measurement confirmed that lauric acid, which was a raw material, was not remained in the crystals.

The thus-obtained solidifying material was added, little by little, to a liquid in which 2 g of fuel oil C floated on 18 g of pure water. As a result, the whole fuel oil C was solidified by 300 mg of the dried solidifying material.

### Example 2

The solidifying material prepared in Example 1 was added, little by little, to a liquid in which 2 g of fuel oil A floated on 18 g of pure water. As a result, the whole fuel oil A was solidified by 400 mg of the dried solidifying material.

### Example 3

The solidifying material prepared in Example 1 was added, little by little, to a liquid in which 2 g of n-tetradecane floated on 18 g of pure water. As a result, the whole n-tetradecane was solidified by 500 mg of the dried solidifying material.

### Example 4

The solidifying material prepared in Example 1 was added, little by little, to a liquid in which 2 g of ethylbenzene floated on 18 g of pure water. As a result, the whole ethylbenzene was solidified by 400 mg of the dried solidifying material.

### Example 5

The solidifying material prepared in Example 1 was added, little by little, to a liquid in which 2 g of cottonseed oil floated on 18 g of pure water. As a result, the whole cottonseed oil was solidified by 500 mg of the dried solidifying material.

Having described our invention as related to the present embodiments, it is our intention that the invention not be limited by any of the details of the description, unless otherwise specified, but rather be construed broadly within its spirit and scope as set out in the accompanying claims.

1. A solidifying material for an organic compound that is liquid at 20° C. and 0.1 MPa,
wherein the solidifying material is obtained by the steps of: dissolving a carboxylic acid, lithium hydroxide, and urea in pure water, to give a solution; gradually cooling the solution; and precipitating crystals in a long fibrous shape from the solution.

2. The solidifying material according to claim 1, wherein the organic compound is a hydrocarbon.

3. The solidifying material according to claim 1, wherein the organic compound is an edible oil.

4. The solidifying material according to claim 1, wherein the precipitated long-fibrous crystals are dried up.

5. The solidifying material according to claim 1, wherein the carboxylic acid is an aliphatic carboxylic acid.

6. The solidifying material according to claim 1, wherein the solidifying material is obtained by further dissolving lithium chloride in the water, in the dissolving step.

7. The solidifying material according to claim 6, wherein the organic compound is a hydrocarbon.

8. The solidifying material according to claim 6, wherein the organic compound is an edible oil.

9. The solidifying material according to claim 6, wherein the precipitated long-fibrous crystals are dried up.

10. A solidifying material for an organic compound that is liquid at 20° C. and 0.1 MPa,
wherein the solidifying material is obtained by the steps of: completely dissolving at least one carboxylate selected from the group consisting of sodium carboxylates and potassium carboxylates, and urea in pure water, to give a solution; adding, to the solution, an aqueous lithium chloride solution; gradually cooling the solution;
and precipitating crystals in a long fibrous shape from the solution.

11. The solidifying material according to claim 10, wherein the organic compound is a hydrocarbon.

12. The solidifying material according to claim 10, wherein the organic compound is an edible oil.

13. The solidifying material according to claim 10, wherein the precipitated long-fibrous crystals are dried up.

14. The solidifying material according to claim 10, wherein the carboxylate is an aliphatic carboxylate.

15. A method of solidifying an organic compound that is liquid at 20° C. and 0.1 MPa, comprising:
solidifying the organic compound, by using the solidifying material according to claim 1.

16. A method of solidifying an organic compound that is liquid at 20° C. and 0.1 MPa, comprising:
solidifying the organic compound, by using the solidifying material according to claim 6.

17. A method of solidifying an organic compound that is liquid at 20° C. and 0.1 MPa, comprising:
solidifying the organic compound, by using the solidifying material according to claim 10.

18. A method of solidifying an organic compound that is liquid at 20° C. and 0.1 MPa, comprising the steps of:
solidifying the organic compound, by using the solidifying material according to claim 1, to give a solid aggregate;
heating the solid aggregates, to decompose into lithium carboxylate crystals and the liquid organic compound;
separating the lithium carboxylate crystals from the liquid organic compound; and
recovering the lithium carboxylate crystals for recycling.

19. A method of solidifying an organic compound that is liquid at 20° C. and 0.1 MPa, comprising the steps of:
solidifying the organic compound, by using the solidifying material according to claim 6, to give a solid aggregate;
heating the solid aggregates, to decompose into lithium carboxylate crystals and the liquid organic compound;
separating the lithium carboxylate crystals from the liquid organic compound; and
recovering the lithium carboxylate crystals for recycling.

20. A method of solidifying an organic compound that is liquid at 20° C. and 0.1 MPa, comprising the steps of:
solidifying the organic compound, by using the solidifying material according to claim 10, to give a solid aggregate;
heating the solid aggregates, to decompose into lithium carboxylate crystals and the liquid organic compound;
separating the lithium carboxylate crystals from the liquid organic compound; and
recovering the lithium carboxylate crystals for recycling.

21. A method of producing a solidifying material for an organic compound that is liquid at 20° C. and 0.1 MPa, comprising the steps of:
dissolving a carboxylic acid, lithium hydroxide, and urea in pure water, to give a solution;
gradually cooling the solution; and
precipitating crystals in a long fibrous shape from the solution.

22. The method according to claim 21, wherein the carboxylic acid is an aliphatic carboxylic acid.

23. The method according to claim 21, wherein, in the dissolving step, lithium chloride is further dissolved in the pure water.

24. A method of producing a solidifying material for an organic compound that is liquid at 20° C. and 0.1 MPa, comprising the steps of:
completely dissolving at least one carboxylate selected from the group consisting of sodium carboxylates and potassium carboxylates, and urea in pure water, to give a solution;
adding, to the solution, an aqueous lithium chloride solution;
gradually cooling the solution; and
precipitating crystals in a long fibrous shape from the solution.

25. The method according to claim 24, wherein the carboxylate is an aliphatic carboxylate.
